(19) United States
(12) Patent Application Publication
(10) Pub. No.: US 2008/0316968 A1
(43) Pub. Date: Dec. 25, 2008

(54) FAST RELAY STATION HANDOVER

(75) Inventors: Yong SUN, Bristol (GB); Dharmayashdev Rai Basgeet, Bristol (GB); Zhong Fan, Bristol (GB)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 12/042,035

(22) Filed: Mar. 4, 2008

(30) Foreign Application Priority Data
Mar. 5, 2007 (GB) 0704223.7

(51) Int. Cl. H04Q 7/00

(52) U.S. Cl. 370/331

(57) ABSTRACT

A method of signalling a handover condition to a mobile station in a network, comprising the steps of determining handover conditions based on the topology in the network; and signalling a handover condition to the mobile station. A base station and relay station operating in accordance with the method are also disclosed.

The present invention relates to a method for initiating fast relay station handover. More particularly it relates to base stations and their extended relaying topology ranging from fixed relay to mobile relay.

Handover (HO) is one of critical issues for mobile applications (see, e.g.: McMillan, D, “Delay analysis of a cellular mobile priority queueing system”, IEEE/ACM Transactions on Networking, Volume 3, Issue 3, June 1995, pp. 310-319, incorporated herein by reference). In wireless systems, especially when relatively small cell sizes or micro-cells are used, the handover procedure has a significant impact on the system's performance. Modern systems and networks have to support seamless handover to enable the mobile station (MS) to switch from one base station to another without interrupting the connection (Hui-Nien Hung; Pei-Chun Lee; Yi-Bing Lin; Nan-Fu Peng, “Modeling channel assignment of small-scale cellular networks”, IEEE Transactions on Wireless Communications, Volume 4, Issue 2, March 2005, pp. 646-652, incorporated herein by reference; and Ruggieri, M.; Graziosi, F.; Santucci, F., “Modeling of the handover dwell time in cellular mobile communications systems”, IEEE Transactions on Vehicular Technology, Volume 47, Issue 2, May 1998, pp. 489-498, incorporated herein by reference). The handover process can be defined as the process by which a mobile station migrates from the point of attachment of a serving base station (BS) to that of a target base station.

So far, there are mainly three handover methods supported within practical applications and existing standards, such as 3GPP (Joyce, R. M.; Griparis, T.; Osborne, I. J.; Graves, B.; Lee, T. M., “Soft handover gain measurements and optimisation of a WCDMA network”, 3G Mobile Communication Technologies, 2004. 3G 2004. 2004, pp. 659-663, incorporated herein by reference; and Petre, F.; Leus, G.; Deneire, L.; Engels, M.; Moonen, M., “Adaptive space-time chip-level equalization for WCDMA downlink with code-multiplexed pilot and soft handover”, ICC 2002, May 2002, incorporated herein by reference) and WiMAX (WiMAX-Forum white paper, “Mobile WiMAX—Part 1: A Technical Overview and Performance Evaluation”, June 2006, incorporated herein by reference):
Hard Handover (HHO)
Fast Base Station Switching (FBSS)
Macro Diversity Handover (MDHO)
   Normally, the HHO is mandatory and others are optional.

Conventionally the handover procedure is based on signal strength from different base stations, which is the most efficient method to support fast handover (Graziosi, F.; Pratesi, M.; Ruggieri, M.; Santucci, F., “A multicell model of handover initiation in mobile cellular networks”, IEEE Transactions on Vehicular Technology, Volume 48, Issue 3, May 1999, pp. 802-814, incorporated herein by reference).

Recent studies have shown that relay technology can enhance the capacity and improve the overall coverage of a cellular system. As expected, the deployment of relay stations (relay stations) within a wireless system brings along a number of challenges with regards to the handover mechanism. In this regard, two major challenges can be formulated: The first one is that for any existing systems, the conventional handover is not straightforward for handover operating between relay stations. The second one is that any system would need to have new feature added into mobile terminal to make fast handover feasible, which adversely increases the complexity and cost of mobile terminal.

U.S. Pat. No. 7,096,022 discloses a system and method for supporting quality of service in vertical handovers between heterogeneous networks. Handover is supported between a mobile host and a corresponding node located in a heterogeneous network. Handover paths are established to accommodate a plurality of quality of service properties. Admission control is performed that considers the established handover paths and an established first reservation path. Gateways are contacted to determine a handover path to use. The determined handover path is used to support vertical handover. A second reservation path is established while maintaining the first reservation path and the handover path.

U.S. Pat. No. 7,149,538 relates to a method for controlling transmission power from a wireless transceiver. Signal to interference ratios (SIRs) are estimated for a signal that is received from another wireless device. An out-of-sync condition between the wireless transceiver and the other wireless device is identified based on the SIRs. Change of the transmission power from the wireless transceiver is restricted based on the SIRs and when an out-of-sync condition has not been identified.

U.S. Pat. No. 7,146,168 refers to a method and system for providing a downlink connection in a cellular network. A feedback information indicating a selected cell is transmitted to a central network element) controlling at least two network elements serving cells of the cellular network. The at least two network elements are controlled by the central network element based on the feedback information so as to establish the downlink connection. Thus, the downlink transmissions of the non-central network elements are controlled by the network so as to decrease performance loss due to reception errors of the feedback information. The feedback information may be a temporary ID obtained in a site selection diversity transmission control scheme.

U.S. Pat. No. 7,120,131 discloses a method of selecting the serving network element in a telecommunications network. Mobility agents or routers transmit attribute information on one or more network elements in advertising messages to at least one mobile node. This information is used in the mobile node for selecting the serving network element.

According to a first aspect of the present invention, there is provided a method of signalling a handover condition to a mobile station in a network. The method comprises the steps of determining handover conditions based on the topology in the network and signalling a handover condition to the mobile station by modifying the normally transmitted power during a subframe which is indicative of the received power at the mobile station.

In a first configuration of the first aspect at least one recommended base station or relay station may be included in the message.

In another configuration of the above aspect the handover conditions may be determined by taking into account, enhancement facts and/or decrease-facts.

In a further configuration of the above aspect the enhancement and/or decrease facts may comprise the hop count, antenna configuration, and/or mobile channel condition.

In a configuration of the above aspect the effective power may be modified in a field of the MAC frame

In yet another configuration of the above aspect the PHY-amble may be modified.

In a further configuration of the first aspect the effective power and the normally transmitted power may be transmitted in sequence.

In another configuration of the above aspect the effective power and the normally transmitted power may be transmitted in parallel.

According to a second aspect of the present invention there is provided a base station in a mobile network. The base station comprises means for determining handover conditions based on the topology in the network; and means for signalling a handover condition to the mobile station by reducing the transmitted power.

In a configuration of the above aspect, the base station may be adapted to operate in accordance with the first aspect or any of its configurations.

According to a third aspect of the present invention there is provided a relay station in a mobile network. The relay station comprises means for receiving a handover condition from a base station based on modified transmitted power; and means for signalling a handover condition to the mobile station by modifying the transmitted power in accordance with the modified transmitted power received from the base station.

In a configuration of the above aspect, the relay station may be adapted to operate in accordance with the first aspect or any one of its configurations.

According to a fourth aspect of the present invention there is provided a signal adapted for signalling a handover condition from a base station to a mobile station in a network. The signal comprises a subframe in which the transmitted power is modified in accordance with a handover condition for the mobile station at the base station.

In a configuration of the fourth aspect the MAC frame may comprise a field to indicate the effective power.

In another configuration of the above aspect the PHY-amble may be modified.

In a further configuration of the fourth aspect the effective power and the normally transmitted power may be transmitted in sequence.

In yet another configuration of the above aspect the effective power and the normally transmitted power may be transmitted in parallel.

According to a fifth aspect of the present invention there is provided a mobile terminal comprising means for determining the effective power and the normally transmitted power from a signal according to the fourth aspect.

In a configuration of the fifth aspect the power determining means may be adapted to detect and evaluate a field in which the effective power and the normally transmitted power are transmitted in parallel.

In another configuration of the above aspect the power determining means may be adapted to detect and evaluate a field in which the effective power and the normally transmitted power are transmitted in sequence.

These and other aspects of the invention will now be further described, by way of example only, with reference to the accompanying figures.

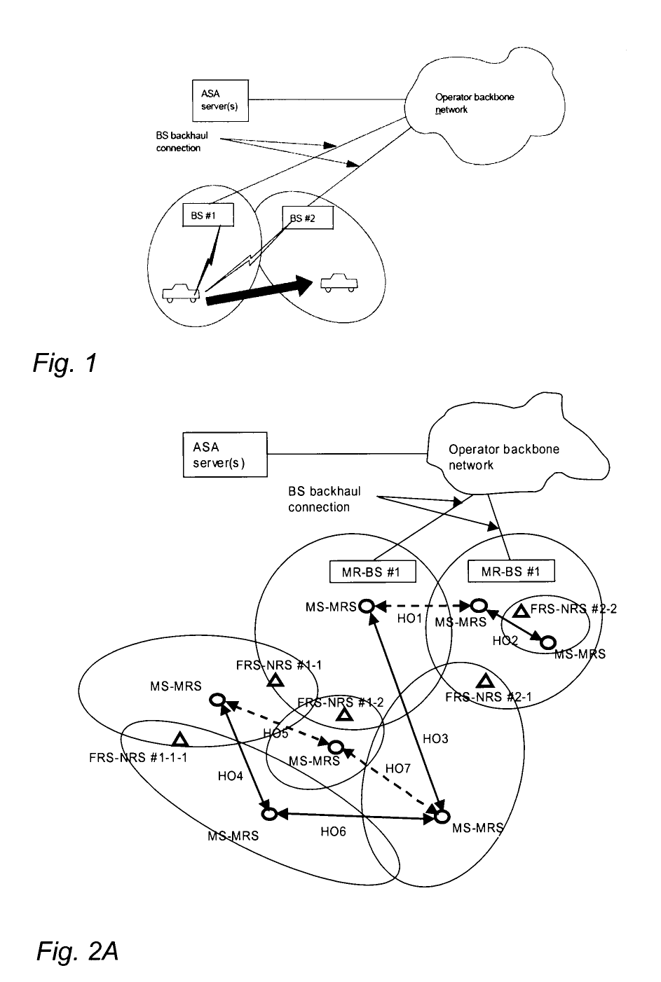

FIG. 1 illustrates a known exemplary network model.

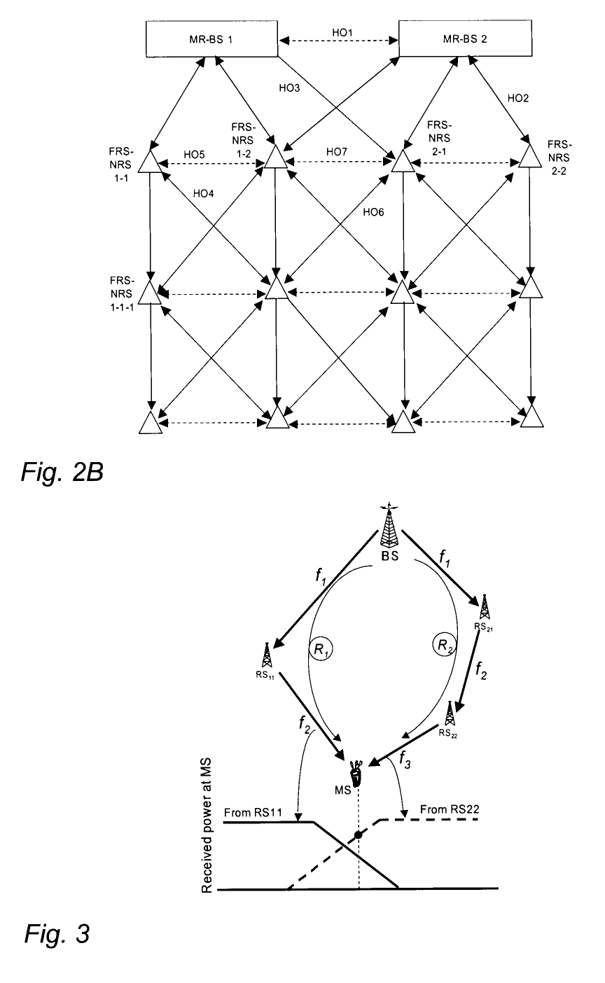

FIG. 2A is an illustration of an exemplary network model for relay deployment in accordance with the present invention.

FIG. 2B shows the topological changes in the corresponding network topology.

FIG. 3 is an illustration of an exemplary scenario of handover within a relay system.

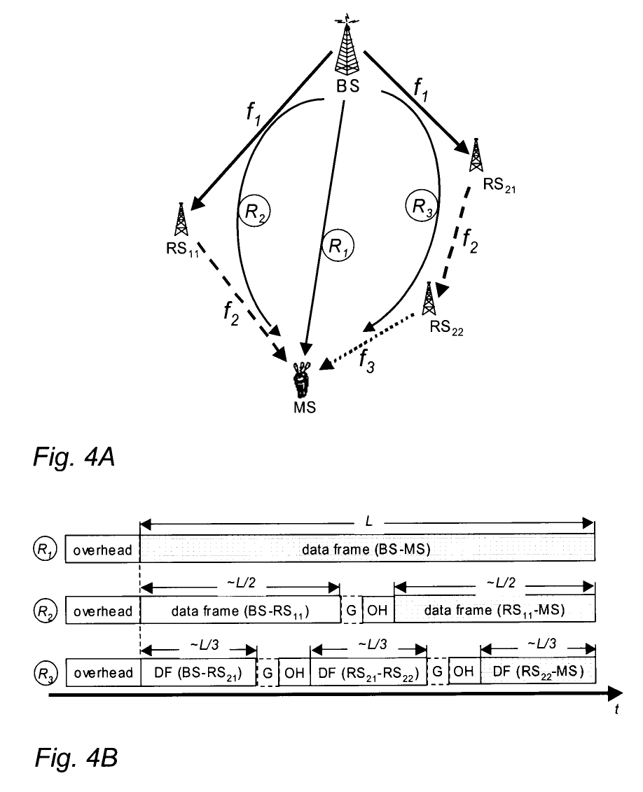

FIG. 4A is an illustration of a case study considering the relay topology only.

FIG. 4B is an illustration of the data frames in the paths illustrated in FIG. 4A.

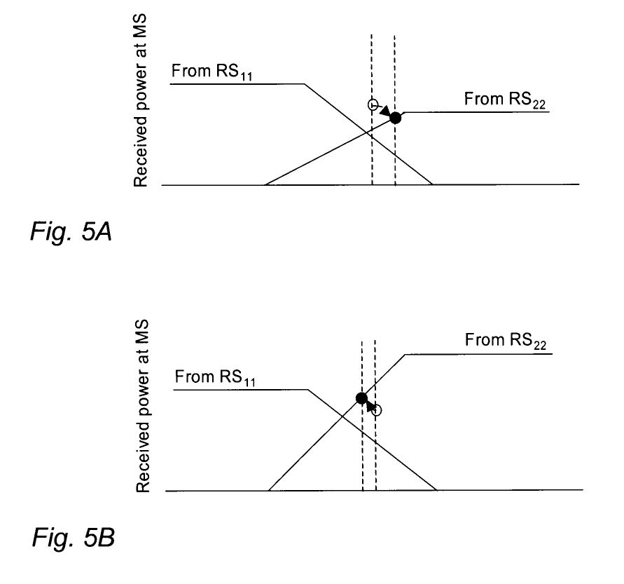

FIG. 5A is an illustration of a handover with effective power indications based on topology.

FIG. 5B is an illustration of a handover with effective power indications based on MIMO consideration.

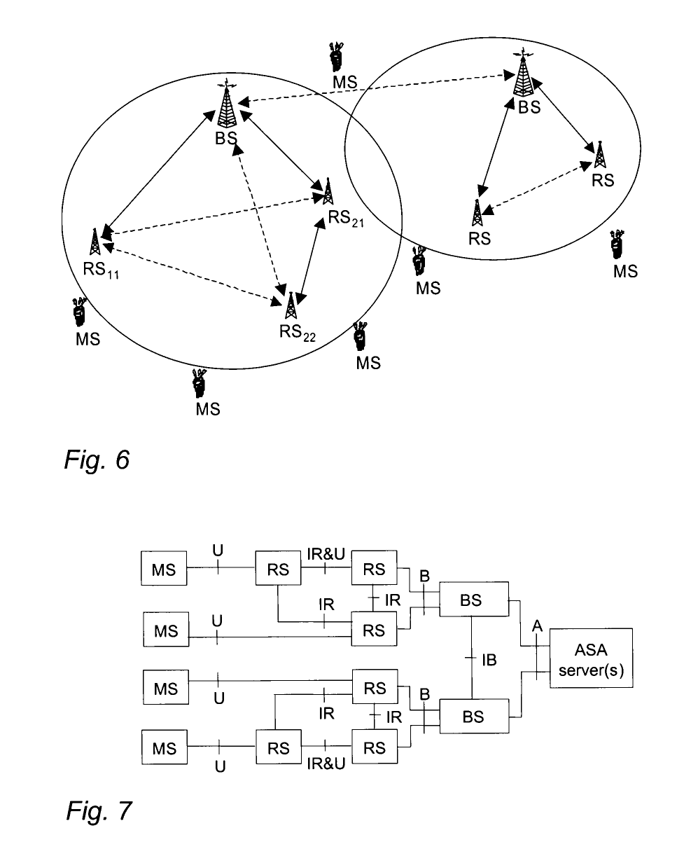

FIG. 6 is an illustration depicting information gathering amongst base stations and relay stations.

FIG. 7 is an illustration of the logical network reference model and control plane.

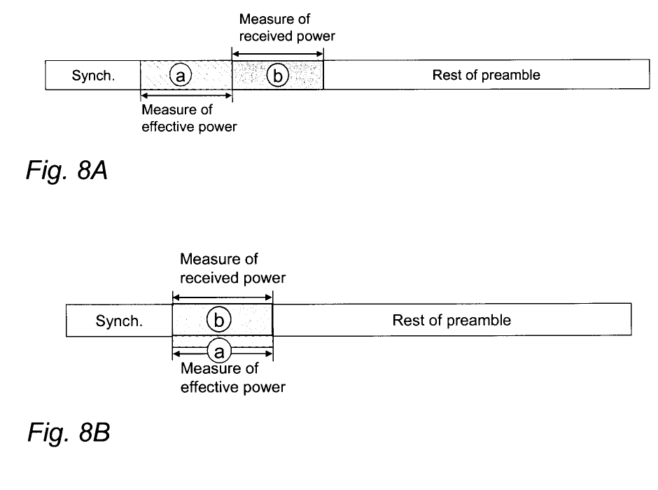

FIG. 8A shows an example of a preamble with sequential transmission of effective power measurement.

FIG. 8B depicts an example of a preamble with parallel transmission of effective power measurement.

Within the three handover methods, as already mentioned previously, the HHO is the simplest scheme for the practical operation since it is only based on signal strength from different base stations. For FBSS, the base station and mobile station maintain a list of base stations (the so-called diversity set), which are involved in FBSS with the mobile station. It requires the mobile station to continuously monitor the base stations in the diversity set and to define an anchor base station. The mobile station only communicates with the anchor base station for uplink and downlink messages. Anchor base station updating procedures are enabled by communicating the signal strength of the serving base station via the channel quality information (CQI) channel (CQICH). A FBSS begins with a decision by a mobile station to receive or transmit data from the anchor base station that may change within the list. The handover can be initiated by either base station or mobile station. For base station initiated handover, the mobile station reports the selected anchor base station on CQICH. Fundamentally, the data is required to transmit simultaneously to all base stations of the diversity set. Similar to operation of the diversity set, a MDHO begins when a mobile station decides to transmit or receive unicast messages and traffic from multiple base stations of the diversity set in the same time interval.

As an example of FBSS decision and initiation (IEEE 802.16e-2006, IEEE Standard for Local and metropolitan area networks, “Part 16: Air Interface for Fixed and Mobile Broadband Wireless Access Systems, Amendment 2: Physical and Medium Access Control Layers for Combined Fixed and Mobile Operation in Licensed Bands”, IEEE, 28 Feb. 2006, incorporated herein by reference), the base station supporting FBSS shall broadcast the DCD (Downlink Channel Descriptor) message that includes the H_Add Threshold and H_Delete Threshold. These thresholds may be used by the FBSS capable mobile station to determine if MOB_MSHOREQ should be sent to request switching to another anchor base station or changing Diversity Set. When mean CINR (mean Carrier to Interference plus Noise Ratio) of a base station is less than H_Delete Threshold, the mobile station may send MOB_MSHO-REQ to request dropping this base station from the diversity set; when mean CINR of a neighbour base station is higher than H_Add Threshold, the mobile station may send MOB_MSHO-REQ to request adding this neighbor base station to the diversity set. In each case, anchor base station responds with MOB_BSHO-RSP with updated diversity Set.

If all links available to a mobile station have similar performance, then the hop number, i.e. the number of relaying steps from the base station to the mobile station could be used as the decisive factor for considering a handover.

For the handover, a network model example can be demonstrated as shown in FIG. 1, where a mobile station represented in the form of a vehicle can move along and hand-over from a first base station BS #1 to a second base station BS #2. Both base stations BS #1 and BS #2 are linked via a base station backhaul connection to the operator backbone network and the ASA servers. More specifically for the relay case scenario which is based on the IEEE 802.16j specification discussed above, three typical usage scenarios (i.e. fixed, nomadic and mobile) has been identified. Also, in the mobile relay, there could be further two different mobile relays, namely, mobile vehicle usage and OTM (on-the-move) operation. The mobile relay station applied to the mobile vehicle usage can be defined as mobile relay station. For mobile relay station application, it is defined as that mobile station devices are travelling together on the mobile vehicle and a mobile relay station is mounted on the vehicle. If we assume that the mobile station can only connect to its mobile relay station, for handover issues, mobile relay station can be treated as the same a mobile station since for mobile relay station, the network only needs to consider the mobile relay station itself (no need to consider its mobile relay station relayed mobile stations). Nomadic relay station (NRS), is similar to fixed relay station (FRS) from handover point of view, since nomadic relay station is fixed when it is operated (it is switched off when it is moving). Taking into account the above description and taking the network model in FIG. 1 into consideration, a new network model for relay deployment can be established as shown in FIG. 2A. The network model comprises a number of base stations MR-BS 1 and MR-BS 2 linked via a base station backhaul connection to the operator backbone network and the ASA servers. A plurality of fixed or nomadic relay stations FRS-NRS 1-1, FRS-NRS 1-1-1, FRS-NRS 1-2, FRS-NRS 2-1, and FRS-NRS 2-2 are linked to mobile relay/base stations MR-BS 1 and MR-BS 2, respectively. As shown by dashed-line arrow HO1, a mobile station or mobile relay station MS-MRS could initiate a horizontal handover between MR-BS 1 and MR-BS 2, which would imply that the topological level of the connection would not change. By contrast, solid-line arrow HO2 illustrates a handover between MR-BS 2 and FRS-NRS 2-2, which would include or eliminate a further hop in the topology. As mobile station or mobile relay station MS-MRS moves further along, further handovers could be initiated, as indicated by solid arrows HO3, HO4, HO6 for vertical handovers, and dashed arrows HO5 and HO7 for horizontal handovers.

FIG. 2B illustrates schematically the topology in the corresponding network considered above. With mobile relay/base stations MR-BS1 and MR-BS2 at the top, the fixed/nomadic relay stations have been arranged in levels corresponding to the number of hops from the base stations. Reflecting the topology illustrated in FIG. 2A, FRS-NRS 1-1, FRS-NRS 1-1-1, FRS-NRS 1-2, FRS-NRS 2-1, FRS-NRS 2-2 have been indicated at their respective distance from the base stations. Relay stations shown at the same level in FIG. 2B have equivalent numbers of hops. Again, solid arrows HO1, HO3, HO4, and HO6 represent vertical handovers for a mobile station or mobile relay station, and dashed arrows HO1, HO5 and HO7 stand for horizontal handovers.

Based on the new network model for relay deployment, some challenges for the fast handover will be highlighted.

For the handover along the horizontal chains, it is still feasible to employ the conventional handover as described previously. However, for the handover along the vertical chains, the conventional handover could be not feasible any more in some scenarios. One example is shown in FIG. 3, illustrating an exemplary scenario of handover within a relay system. As shown in the topology, mobile station MS can connect to base station BS either via path R1 (BS-RS₁₁-MS) or path R (BS-RS₂₁-RS₂₂-MS). When the received power from relays station RS₁₁ at the mobile station MS drops below a particular value, and received power from RS₂₂ becomes higher, mobile station MS should initiate handover from RS₁₁ to RS₂₂. This demonstrates that the mobile station should handover to RS₂₂, but in fact the RS₁₁ could be still the better link than the link to RS₂₂. The reason is that path R1 (BS→RS₁₁→MS) is only 2-hop but path R2 (BS→RS₂₁→RS₂₂→MS) is 3-hop, which could imply less capacity or degraded performance.

Basically in multi-hop system, the signal strength (or mean CINR) will not be enough to determine a handover since the number of resources available at the target base station/relay station needs to be taken into account as well. A possible solution would be to increase the complexity of the mobile station so that the latter is fully aware of the network topology and the corresponding relaying strategies which are involved.

The present invention proposes a novel mechanism which transforms the relay topology and performance metrics to power indications on each relay station to enable fast handover. Note that the power indications are actual the power levels transformed to reflect network topologies and link level qualities among base station and relay stations. The power levels can be detected by a mobile station during handover procedure. These power levels might be different from the transmit power levels for a base station or a relay station on its data transmission. However, a mobile station might be able to make a fast decision on handover based on these effective power indications.

The core concept of this invention is to establish a mechanism in order to allow the network to transfer its supported relay topology and relay link performance into effective power indications. The power indication can be directly read by a mobile station or effectively detected by a mobile station, such as in a mobile station's correlation processing to detect the received power. Detailed implementation and operation issues will be described in the next section. With this procedure, it is easy for the mobile station to initiate a handover. On the other hand, using the present invention, the base station can initiate a handover and the handover request will be easy to match that on the mobile station to avoid unnecessary rejection (which could be due to bad link quality or unavailability of resources on the target base station). Furthermore, even for a common mandatory handover requested by a base station, the base station shall advantageously include at least one recommended base station/relay station in the message (and normally greater than one base station/relay station), it is still possible to be rejected by the mobile station. Therefore it is proposed to set up a tunnel for the network and its mobile station to match their measurement together to achieve fast handover. The key advantage of this scheme is to establish fast handover and meanwhile avoid unnecessary/frequently handover.

The mechanism is mainly operated on base station and its relay stations. All base stations and their relay stations should be fully aware of the network topology and networking performance among them. This applies especially to those relay stations which are belong to the operator to form an entire relaying network with base stations. Consequently, the base stations and/or relay stations should provide direct indications to their mobile stations. These indications should include all the topology and networking information.

As already described previously, the handover mechanism is mainly based on received signal power strength, especially for fast handover. Therefore, a mechanism to transfer network topology and performance to power indication is proposed. There are several parameters in this transformation and the latter can be categorised as follows: First it refers to the parameters which increase the network efficiency and performance. The second considers all those parameters which decrease the network efficiency and performance. Based on these considerations, an effective power indication can be defined as

$${ξ}_{power} = \frac{{ξ}_{enhancement\_facts}}{{ξ}_{decrease\_facts}} \cdot P \qquad ( 1 )$$

where ξ represents the term ‘effective indication’. Consequently, ξ_{power} denotes the effective indication of power. ξ_{enhancement}_{_{—}}_{facts} denotes the effective indication of all facts which enhance the system efficiency and performance. ξ_{decrease}_{_{—}}_{facts} denotes the effective indication of all facts which degrade the system efficiency and performance. P is a general term which denotes a power and the power can be on base station, relay station or others. Therefore, this forms a complete effective power indication (EPI).

As it is fairly easy to understand that the facts depend strongly on specific topology, configuration and application scenarios, including geography and positions. The facts in major considerations are those related to network operation and system transmission, such as hop number in relay, antenna configuration, mobile channel condition, etc.

Furthermore, for simplifying expression, we can set the enhancement facts as ‘positive facts’, abbreviated as P-facts. In contrast, N-facts (negative facts) stand for the decrease-facts. A value ‘1’ is defined as meaning that there is not any enhancement or any degradation.

In order to clarify the descriptions, several case studies and definitions are presented in the following subsections. These case definitions might not cover all applications; however, any extension of cases and applications should be easily followed. The purpose of the case study is only to make simple situation for clearer description.

In the case of multi-hop topology, the pure topology is considered, assuming that all links between the base station and the relay stations and the mobile stations are the same on configuration and performance. Based on FIG. 3 an example of this case can be demonstrated as shown in FIG. 4A. In this case, a TDD (Time Division Duplexing) is applied for radio resource allocation and assignment. It is shown clearly in FIG. 4B that the portion occupied by the mobile station is reduced by the increase of hop numbers, as highlighted in the frame structure. Path R1 allows the mobile station Ms to connect directly to the base station, therefore it may occupy the total length L of the data frame. In path R2, the effective length of the frame is halved, due to the introduction of one hop, i.e. the data frame for BS-RS11 and the data frame for RS11-MS each have less than L/2 available when the additional guard period G and additional overhead OH are taken into account. With two hops in path R3, the effective length of the frame is duced a less than L/3.

Firstly we assume that the transmit power levels are the same on both base station and relay stations, where P can be normalised to 1. In this case, a mobile station could be closer towards to the relay station with 3-hop. However, it could find out that the handover was not necessary, which is a decrease in the performance. It may therefore be necessary to hand over back to keep the link quality.

For this simple multi-hop case, the network can easily assign the effective facts to the base station (BS) and each relay station (RS) as listed in Table 1.

TABLE 1
EPI with multi-hop

| Stations | Hop number | P-facts | N-facts | ξ_{power} |
|---|---|---|---|---|
| BS | 1 | 1 | 1 | 1 |
| RS₁₁, RS₂₁ | 2 | 1 | 2 | 0.5 |
| RS₂₂ | 3 | 1 | 3 | 0.3333 |

Please note here that the effective power indications are only set on base station and relay stations and the indications are not the exact values. Also, the indications are only employed for fast handover procedure, which are not the power level for data transmission. Therefore, based on (1), we can derive a expression for this case as

$${ξ}_{power , i} = \frac{P}{{N}_{hop , i}} \qquad ( 2 )$$

where i denotes a index of base station and relay station, N_{hop,i} represents the number of hops.

FIG. 5A depicts a handover with effective power indication (EPI) based on topology. With the EPI, and based on the handover shown in FIG. 5A, the new handover is demonstrated in FIG. 5B. In handover with effective power indications based on MIMO considerations the mobile station will reasonably ‘stay longer’ with RS₁₁.

Normally, the base station EIRP (Equivalent Isotropically Radiated Power) is much higher than that on relay stations and EIRP values are the same at relay stations (unless for any other specific design). In this case, the base station has the higher priority to keep the link with the mobile station.

In this situation of different EIRP or transmit power, (2) becomes

$${ξ}_{power , i} = \frac{{P}_{i}}{{P}^{BS} \cdot {N}_{hop , i}} \qquad ( 3 )$$

where P^{BS} represents the EIRP or transmit power of base station. It shown that all access station is normalised to its base station.

Each of the access stations could have its own antenna configurations, such as multiple antenna sets for multiple-input multiple-output (MIMO) configuration. As it is well-known that MIMO has higher transmission efficiency than that of SISO (single-input single-output), the weights of MIMO is high, eventually. Referring to FIGS. 4A and 4B, if the path-3 has a MIMO configuration and path-2 has a SISO configuration. Also for a simple case, we assume that the mobile channel has no limitation on any configurations. Consequently we can have different effective power indication as shown in Table 2, where MIMO 2×2 is considered

TABLE 2
EPI with MIMO 2 × 2 on path-3

| Stations | Hop number | P-facts | N-facts | ξ_{power} |
|---|---|---|---|---|
| BS | 1 | 2 | 1 | 2 |
| RS₁₁ | 2 | 1 | 2 | 0.5 |
| RS₂₁ | 2 | 2 | 2 | 1 |
| RS₂₂ | 3 | 2 | 3 | 0.6667 |

For these indications, the mobile station is more encouraged to make a handover to RS₂₂ from RS₁₁, especially if the mobile station has the MIMO capability as well. This handover is illustrated in FIG. 5B on this specific case. And, based on equation (3) it can be derived as

$${ξ}_{power , i} = \frac{{P}_{i} \cdot {ξ}_{antenna}}{{P}^{BS} \cdot {N}_{hop , i}} . \qquad ( 4 )$$

Here in (4) we introduce another effective indication of antenna, ξₐₙₜₑₙₙₐ which includes effective spatial multiplexing and effective spatial diversity.

Link quality is another important issue and for this scenario, we set up a simple scenario to link the channel link quality in context of this new idea. We still use the previous FIG. 6 and set two different link qualities with simple BPSK and QPSK (QPSK doubled capacity of BPSK). For the pathR2, we assumed that it could support QPSK. In contrast, for the pathR3, even though it is equipped with MIMO but the channel condition can only support BPSK. If we set the fact of the basic BPSK to ‘1’, the fact of QPSK becomes 2. The effective power indications can be derived in Table 3.

TABLE 3
EPI with consideration of channel link quality

| Stations | Hop number | P-facts | N-facts | ξ_{power} |
|---|---|---|---|---|
| BS | 1 | 2 | 1 | 2 |
| RS₁₁ | 2 | 2 | 2 | 1 |
| RS₂₁ | 2 | 2 | 2 | 1 |
| RS₂₂ | 3 | 2 | 3 | 0.6667 |

Then, the condition of the recommended handover for the mobile station is more towards RS₁₁.

For this case, it is more efficient for make 1 bit/Hz as an effective indication. say, ‘1’ represents 1 bit/Hz and other values of ‘bit/Hz’ should be scaled to ‘1 bit/Hz’. Therefore, based on equation (4), we can derive

$${ξ}_{power , i} = \frac{{P}_{i} \cdot {ξ}_{antenna} \cdot {n}_{b}}{{P}^{BS} \cdot {N}_{hop , i}} . \qquad ( 5 )$$

where n_{b} represents number of bits per Hz. Note that n_{b} may not be an integer as considering both modulation and coding.

The above three cases are discussed as examples. There might be many other important facts need to be considered within the transformation of the effective power indications, such as latency, ranging, QoS requirement, etc. However, the transformation should follow the same concept. The detailed implementation and operation techniques is described in the next session.

All the information for the proposed effective power indication transformation can be directly or indirectly obtained. Fundamentally, all the base stations and relay stations should fully aware of their topology and relay stations is proposed to directly or indirectly communicate with their base station. Also, between base stations, it is also able to have message transmission, as shown in FIG. 6. Noted that the indirectly communication between relay station to base station is the communication through another relay station. Also, the indirectly communication between relay station and relay station is the communication through base station. Consequently each relay station is able to obtain information of other relay stations through its base station. However, for base station to base station, the communication might be through its backbone network.

With this setup all information will be gathered before any communication to a mobile station or mobile stations. This makes indications more efficient to mobile stations as mobile station has no burdens or constrains from network modification or even new setup of network.

From this, a logical network reference model and control plane is depicted in FIG. 7, where the reference points are specified in Table 4.

TABLE 4
Definitions of reference points

| Reference | |
|---|---|
| point | Elements to be specified |
| U | PHY, MAC (including CS) operations, including message |
| | exchanges for mobility support |
| IB | base station-to-base station messages |
| IR | relay station-to-relay station messages |
| A | Message serving mobile station and relay station (e.g. mobile |
| | relay station) authentication and service authorisation |
| | functions |
| B | Messages serving mobile station and relay station (e.g. mobile |
| | relay station) authentication |

The implementation and operation of the transformation are highly dependent upon to the relay deployment scenarios i.e. fixed relay, nomadic relay or mobile relay. For a fixed relay deployment, the base station and relay station can easily pre-set the most facts of the effective power indications. For nomadic relay, the facts setup should follow the location changes of the relay stations. For mobile relay, the network needs to update the facts with the transmission.

Also, the implementation and operation are depended on message exchange between network and mobile terminal, or say, mobile station (MS). Clearly, it is also the situation on application as to new system or existing system. And, for an existing system, it is also different on whether a mobile station can be modified or nor. Consequently we have three different situations.

For a new system or fully modifiable mobile station of an existing system, there is no any constrains on implementation and operation. In this case, there are mainly two techniques proposed here.

The first one is with MAC support, which has a field insert to indicate the effective weight. This will depend on different systems and MAC frame structures but fundamentally there needs a field to have the ξ_{power} to be delivered to a mobile station and the mobile station should fully aware of the indication of ξ_{power} and an example is shown in Table 5.

TABLE 5
A field for weights of effective power indications.

| | Type | | |
|---|---|---|---|
| Name | (1 byte) | Length | Notes |
| Weight of effective | — | 4 bits | 16 levels |
| power indication | | | indications |

In this situation, all base station and relay stations are transmitting as normal way without other changes. However, by this means, the mobile station should be able to detect the received power as any system transmission. However, as long as it realises the weights of the effective power indications, it should apply the weights to the received power to be with its handover procedure and decision.

The second one is to add a part to or modify the PHY-amble (such as pre-amble, mid-amble or post-amble) to enable the measurement of the effective power measurement. An example of this on preamble is shown in FIG. 8A. This is a sequential operation: as a mobile station achieves the synchronisation, it can measure the effective power first (‘a’ sequence) and then measure the normal received power (‘b’ sequence). Alternatively, it may be operated in parallel as shown in FIG. 8B. In this case, the ‘a’ sequence can be added on top of the ‘b’ sequence but it requires that ‘a’ is orthogonal with ‘b’.

For the ‘a’ sequence, transmitter has to add the weight of the effective power and thereby at the receiver end, the mobile station can apply the normal power detection procedure. Further option can combine ‘b’ sequence with synchronisation sequence (the ‘Synch.’ part) and add the ‘a’ sequence on the top the ‘synch.’ sequence. However, all these are implementation options, which will be feasible to adopt in different system design.

However, for an existing system where no any modification is allowed for any mobile stations, this becomes constrain on implementation and operation. In this case, a base station or a relay station has to modify its original indications, wherever available. Noted that for this kind of application, mobile station has no prior knowledge of relay stations. However, all the relay stations could be treated as base stations for the mobile station. Therefore, from mobile station's point of view, all neighbour base stations or relay stations are base stations. Therefore, for any indication related to base station or relay station must be originally for base station. Also for the first stage of handover of access station reselection, mobile station may use neighbour base station/relay station information, or may make a request to schedule scanning intervals or sleep-intervals to scan, and possibly range, neighbour base station/relay station for the purpose of evaluating mobile station interest in handover to potential target base station/relay station. Consequently, there are a few parameters could be weighted by the effective power as new indications for fast handover. Since it is heavily based on a existing system, these will be considered in more detail below.

As the effective power transformation is operated on base stations and/or relay stations, it is much more feasible for network control. For moving mobile stations, handover is essential. However, much frequently handover will reduce network efficiency. Also, handover will cause large latency. With the effective power transformation, it avoids unnecessary handover and meanwhile achieves fast handover to reduce latency as the indication can be easily detected by a mobile station in moving. Furthermore, it is also easy for network control on a mobile station by effective indication.

The present invention may be better appreciated in the light of the following examples. As indicated clearly in the previous section the application of the proposed effective power indication transformation in an existing system is totally dependent on any available existing indications. Here in this section a couple of indications are described as examples only.

(1) Neighbour base station Advertisement Information (NBS_ADV_info)

For coverage reselection, mobile station may use Neighbour base station Advertisement Information acquired from a decoded NBS_ADV_info. For this operation, base station or relay station has to broadcast the NBS_ADV_info.

For the NBS_ADV_info related to the proposed effective power indication transformation, it normally has number of neighbour, BSID (base stations' IDs), base station EIRP (Equivalent Isotropically Radiated Power) indicators, base station EIRP values, DCD (Downlink Channel Descriptor) configuration change count, UCD (Uplink Channel Descriptor) configuration change count, etc.

Among these parameters, base station EIRP indicators and base station EIRP values are the two which could be possible to apply the weights of the effective power to transfer to the effective power indications. DCD and UCD could be used to further indicate the configuration change. A simplified NBS_ADV_info Syntax of this part is shown in Table 5. Here, the previous EIRP value is transferred to the effective EIRP value as the weight of the effective power is applied to the EIRP value.

TABLE 5
A simplified NBS_ADV_info Syntax

| Syntax | | Size | Notes |
|---|---|---|---|
| NBS_ADV_info( ) { | | — | — |
| | If(BS EIRP | — | — |

Indicator == 1) {

| | BS effective EIRP | 8 bits | Signed Integer from −128 to |
|---|---|---|---|
| | | | 127 in unit of dBm. This field |
| | | | is present only if the BS EIRP |
| | | | indicator is set in PHY Profile |
| | | | ID. Otherwise, the BS has the |
| | | | same EIRP as the serving BS. |
| | } | — | — |
| | DCD Configuration | 4 bits | This represents the 4 LSBs of |
| Change Count | | | the Neighbour BS current DCD |
| | | | configuration change count |
| | UCD Configuration | 4 bits | This represents the 4 LSBs of |

| Change Count | | | the Neighbour BS current UCD |
|---|---|---|---|
| | | | configuration change count |
| | } | — | — |

| | | |
|---|---|---|
| } | — | — |

Ideally, a base station shall broadcast information about the network topology using the NBR-ADV_info message. The message provides channel information combined with weight of effective power for neighbouring base stations and relay stations normally provided by each base station/relay station's own DCD/UCD message transmissions. A base station may obtain that information over the backbone and a relay station may obtain that information from its base station. Availability of this information facilitates mobile station synchronization with neighbouring base station or relay station by removing the need to monitor transmission from the neighbouring base station or relay station for DCD/UCD broadcasts.

### (2) Make a Request to Schedule Scanning Intervals or Sleep-Intervals to Scan Neighbouring Base Station/Relay Station

The mobile station might send a scan request message (SCN-REQ) to request a scanning interval for the purpose of seeking available base stations and determining their suitability as targets for handover. A mobile station may request the scanning allocation to perform scanning or non-contention association ranging. It is worth noting that the base stations mentioned here, in fact, include all available relay stations, but only that the mobile station cannot recognise relay stations.

Upon reception of the SCN-REQ message, the base station shall respond with a scan response (SCN-RSP) message. With this SCN-RSP, the proposed effective power indication would be integrated with the procedure and operation.

Firstly, the SCN-RSP could specify scan duration, report mode, report metric, start frame, scanning type, etc. Secondly, it could recommend scanning base stations/relay stations. Furthermore, it could assign a unique code (such as a CDMA code) to a mobile station to be used for association with the neighbour base station or relay station. With all these, base stations/relay stations could specify a certain period and employ the technique described in FIG. 8B with weighted effective power indication for mobile station to perform scanning. The scanning results, such as RSSI, could be effective RSSI or normal received RSSI, which is determined by base station/relay station whether it transmits the sequence with unique code in weighted effective indicator or a normal sequence.

With the descriptions above in this section, it makes the fast handover feasible among base stations and relay stations.

The present invention provides support for fast relay station handover without any requirements of modifications on mobile terminal for both existing system/standard and future new network. However, if the mobile terminal can be modified, the present invention may provide further support to handover applications.

No doubt many other effective alternatives will occur to the skilled person. It will be understood that the invention is not limited to the described embodiments and encompasses modifications apparent to those skilled in the art lying within the spirit and scope of the claims appended hereto.

1. A method of signalling a handover condition to a mobile station in a network, the method comprising the steps of:
determining handover conditions based on the topology in the network;
signalling a handover condition to the mobile station by modifying the normally transmitted power during a subframe which is indicative of the received power at the mobile station.

2. The method according to claim 1, further comprising including at least one recommended base station or relay station in the message.

3. The method according to claim 1, wherein the handover conditions are determined by taking into account, enhancement facts and/or decrease-facts.

4. The method according to claim 3, wherein the enhancement and/or decrease facts comprise the hop count, antenna configuration, and/or mobile channel condition.

5. The method according to claim 1, wherein the effective power is modified in a field of the MAC frame.

6. The method according to claim 1, wherein the PHY-amble is modified.

7. The method according to claim 6, wherein the effective power and the normally transmitted power are transmitted in sequence.

8. The method according to claim 6, wherein the effective power and the normally transmitted power are transmitted in parallel.

9. A base station in a mobile network, the base station comprising
means for determining handover conditions based on the topology in the network;
means for signalling a handover condition to the mobile station by reducing the transmitted power.

10. The base station according to claim 9, adapted to operate in accordance with the method according to claim 1.

11. A relay station in a mobile network, the relay station comprising.
means for receiving a handover condition from a base station based on modified transmitted power;
means for signalling a handover condition to the mobile station by modifying the transmitted power in accordance with the modified transmitted power received from the base station.

12. The relay station according to claim 11, adapted to operate in accordance with the method according to claim 1.

13. A signal adapted for signalling a handover condition from a base station to a mobile station in a network, the signal comprising a subframe in which the transmitted power is modified in accordance with a handover condition for the mobile station at the base station.

14. The signal according to claim 12, wherein the MAC frame comprises a field to indicate the effective power.

15. The signal according to claim 12, wherein the PHY-amble is modified.

16. The signal according to claim 12, wherein the effective power and the normally transmitted power are transmitted in sequence.

17. The signal according to claim 12, wherein the effective power and the normally transmitted power are transmitted in parallel.

18. A mobile terminal comprising means for determining the effective power and the normally transmitted power from a signal according to claim 13.

19. A mobile terminal, wherein the power determining means are adapted to detect and evaluate a field in which the effective power and the normally transmitted power are transmitted in parallel.

20. A mobile terminal, wherein the power determining means are adapted to detect and evaluate a field in which the effective power and the normally transmitted power are transmitted in sequence.
